(19) United States
(12) Patent Application Publication
(10) Pub. No.: US 2005/0246661 A1
(43) Pub. Date: Nov. 3, 2005

(54) Associating physical items with recorded information

(76) Inventor: Udo Klein, Maximiliansau (DE)

Correspondence Address: FISH & RICHARDSON, P.C., PO BOX 1022, MINNEAPOLIS, MN, 55440-1022, US

(21) Appl. No.: 10/835,935

(22) Filed: Apr. 30, 2004

(51) Int. Cl. G06F 3/00; G06F 17/24

(52) U.S. Cl. 715/811; 715/780; 715/507

(57) ABSTRACT

A computer system that a person uses in relation with a physical item may detect a pre-identified physical item that is present in a physical area associated with a user. The system may identify, in recorded information associated with the pre-identified physical item, a category of the recorded information to be retrieved upon detecting the presence of the pre-identified physical item. The category may be identified based on analyzing previous user inputs. At least a portion of the recorded information that belongs to the identified category is retrieved. The retrieved portion may be displayed in a graphical user interface, wherein the displayed retrieved portion can be used in inputting information relating to the pre-identified physical item.

### TECHNICAL FIELD

This description relates to associating a pre-identified physical item that is present in a physical area with recorded information relating to the item.

### BACKGROUND

Even in the current trend toward developing an essentially “paperless” office environment, it is not uncommon for a user to be entering data from a physical item such as a paper document into a computer system. For example, invoice processing frequently requires a person to physically take possession of an invoice, open a relevant computer software application, enter information from the invoice, and save the entered information in the system. Typically, data entry is done using special forms that can be displayed in a graphical user interface (GUI). Such GUI forms may include at least one input field that is labeled so that the user knows what information to enter there. For example, the GUI form may include a field for entering the invoice number.

The person doing data entry reads the required information from the invoice. When there is more than one invoice in the person's work place, such as on her desk, she may be able to sweep the area with her eyes to find out which invoices are there, or to identify a specific invoice number, for example. Existing computer systems, in contrast, may not be able to detect what physical items are present in the work place.

Some techniques have been introduced for identifying physical items such as documents. They include barcode labels and radio frequency identification (RFID) tags. A barcode can be read with a scanner and a signal from an RFID tag can be detected with an RFID detector. Typically, the scanning of a barcode results in the system obtaining the information encoded in the barcode label; that is, perhaps the invoice number or another unique identifier. In such systems, the barcode-labeled item may not have previously been identified in the system but is registered by the act of scanning it. An RFID tag may be used in an analogous way, with the system becoming aware of the item by receiving the signal from the RFID tag.

These systems are primarily used for tracking the labeled physical items. That is, once the item is scanned or the RFID signal detected, the system can store some information about where the item is located (based on knowing where the scanning/detection was made). Such systems may be associated with disadvantages. For example, it may be both expensive and difficult to integrate existing application programs with the tracking system. Any application programs that are not integrated with the tracking system cannot offer any user benefits from the document tracking, because they are not aware of the document(s) currently present in the user's work space. Moreover, the tracking systems do not offer any learning feature for determining associations between documents that are present and recorded information that relates to those documents.

### SUMMARY

The invention relates to associating physical items with recorded information. In a first general aspect, a method comprises detecting, in a computer system, a pre-identified physical item that is present in a physical area associated with a user. The method comprises identifying, in recorded information associated with the pre-identified physical item, a category of the recorded information to be retrieved upon detecting the presence of the pre-identified physical item. The category is identified based on analyzing previous user inputs. At least a portion of the recorded information that belongs to the identified category is retrieved.

In selected embodiments, analyzing the previous user inputs comprises automatically determining an association between the category and an input field of the computer system. Automatically determining the association may comprise monitoring, over a period of time, physical items that are present in the physical area and user inputs made in the input field. The method may further comprise creating a record reflecting which of the physical items are present in the physical area when each of the user inputs is made, and comparing the record with pre-recorded information associated with the physical items to identify at least one instance when one of the user inputs made while one of the physical items is present in the physical area matches with at least part of the pre-recorded information associated with the physical items. When multiple instances including the at least one instance are identified, the association may be determined using at least one of a data mining technique, a text mining technique, a machine learning technique and a method of statistical analysis.

In selected embodiments, the retrieved portion is displayed in a graphical user interface, wherein the displayed retrieved portion can be used in inputting information relating to the pre-identified physical item.

In a second general aspect, a computer system comprises a computer device with which recorded information that is associated with a pre-identified physical item can be accessed, and a detector device that detects the pre-identified physical item in a physical area associated with a user, wherein the system retrieves at least a portion of the recorded information upon detecting the pre-identified physical item, the portion belonging to a category of the recorded information that is identified based on analyzing previous user inputs.

In selected embodiments, the detector device detects the pre-identified physical item by one selected from the group consisting of: scanning the pre-identified physical item and receiving a communication from the pre-identified physical item. The detector device may do at least one selected from: reading a bar code located on the pre-identified physical item and receiving a signal from an RFID tag located on the physical item.

In selected embodiments, the system monitors, over a period of time, physical items that are present in the physical area and user inputs made in an input field.

Advantages of the invention may include any or all of the following. Providing that a system can offer document tracking-related advantages in an application program that is not aware of the tracking that is being performed. Improved usability of applications that are not integrated with an item tracking system. Providing a learning feature that identifies correlations between present items and recorded information relating to those items. Improved data entry relating to a physical item. Reduced work load in data entry operations. Reduced risk for human errors in data entry operations. Configuring specific aspects of a computer system depending on physical items located near the user's work station. Increased efficiency in creating electronic versions of physical documents. Improved inputting of information in a computer for accessing a specific file.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 is a conceptual diagram of a system that detects a pre-identified physical item;

FIGS. 2A-C are examples of GUIs that can be displayed in the system shown in FIG. 1;

FIG. 3 is a flow chart of a method according to an embodiment of the invention; and

FIG. 4 is a block diagram of a general computer system.

Like reference numerals in the various drawings indicate like elements.

### DETAILED DESCRIPTION

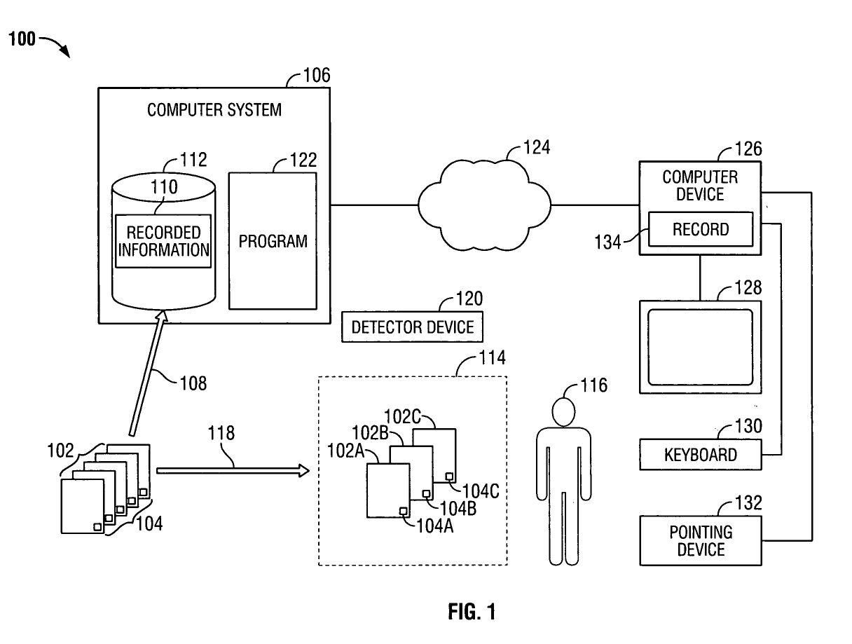

FIG. 1 shows a system 100 that can detect a pre-identified physical item. As will be described below, upon detecting that a pre-identified physical item such as a document is present in a user's work place, the system retrieves a portion of recorded information regarding that item. The retrieved portion belongs to a category of the recorded information that is identified based on analyzing previous user inputs. Particularly, the system may monitor user inputs over time to learn an association between the user inputs and the category or categories of the recorded information.

Assume that the system 100 is used by an organization that handles incoming invoices 102. The organization will process the invoices 102, ultimately resulting in the invoices being paid. The processing may consist of several steps, of which some or all involves the use of computers. For example, an initial step may involve creating an “electronic version” of the invoice such that it can be routed through the organization's computer system. It may also be necessary to enter the due date of the invoice in an electronic calendar or docket to ensure timely payment. Subsequent steps may involve verifying the accuracy of the invoice and resolving any issues that it presents. Different physical items may require different processing and invoices 102 are only one example of the physical items with which the system 100 can be used.

When the organization receives invoices 102, each of them may be provided with one of unique identifiers 104 such that the system 100 can detect the presence of that invoice. The identifiers 104 may comprise any of several technologies. For example, any of the identifiers 104 may comprise a barcode that can be read with a scanner. As another example, any of the identifiers 104 may comprise an RFID tag that can be detected with a suitable detector. Any other machine-readable label, mark, tag or transmitter that can be applied to or fastened to a physical item may be used. Several different types of identifiers 104 may be used if the system 100 is provided with a corresponding detector for each type.

Information regarding the invoices 102 also is recorded in a computer system 106, as indicated by the arrow 108. This initial recording is done such that the system 100 can conveniently provide at least portions of the recorded information in subsequent processing of the invoices 102. The recording 108 may therefore be thought of as a pre-identification of the invoices. The organization may choose to focus the recording 108 on certain information about the invoices 102 that users typically have to enter in subsequent processing. For example, invoice numbers, names of the payees, due dates, internal department numbers or other data regarding the invoices may be recorded. The recording can be done by manual data entry or equipment that optically recognizes characters, to name just two examples. When physical items other than invoices are used, other characteristics can be used. Recorded information 110 may be stored in a data repository 112 of the computer system 106. The recorded information may be stored such that it can be retrieved using specific ones of the identifiers 104. That is, the information recorded for a particular invoice can be retrieved by searching the repository 112 with that invoice's identifier.

During processing of the invoices 102, a few invoices 102A, 102B and 102C are brought into a work place 114. The work place 114 may be associated with a particular user 116 of the system 100, such as a person responsible for some or all of the invoice processing. For example, the work place 114 may be the user's desk, office or storage area. The introduction of the invoices 102A-C into work place 114, indicated by arrow 118, may occur in different ways. For example, the user 116 picks up the invoices 102A-C elsewhere and carries them into work place 114. As another example, the invoices 102A-C are delivered to the work place 114. The invoices 102A-C are available to the user 116 at least while they are in the work place 114.

A detector device 120 detects the invoices 102A-C that are present in the work place 114. This detection may be done in different ways depending on the types of identifiers 104A-C that the invoices 102A-C have. For example, a barcode scanner can read any of the identifiers 104A-C that comprise barcodes; an RFID detector can receive a communication from any of the identifiers 104A-C that are RFID tags; a magnetic stripe reader can read any of the identifiers 104A-C that comprise magnetic stripes, and so on. Preferably, the detector device 120, or the work place 114, or both, are arranged and configured such that the invoices 102A-C are automatically detected when they are brought into the work place 114. RFID signals may be detectable within a large room or warehouse depending on transmitter/receiver characteristics and the presence or absence of obstacles, and barcodes may be scanned within a distance of a few feet, to name just a few examples. As another example, the detection may require a specific user action, such as swiping a magnetic strip through an opening in a reader. It follows that a larger or smaller physical area may be designated as the work place 114 depending on the technology used by the identifiers 104A-C. One or more detector devices 120 may be used in different physical areas encompassed by the system 100.

The detector device 120 transmits a signal to the computer system 106 indicating that the invoices 102A-C have been detected. A program 122 includes executable instructions for retrieving at least a portion of recorded information 110 upon receipt of the signal. The retrieved portion may be transmitted via a network 124 to one or more computer devices 126 accessible to the user 116. As is known, a computer device may be connected to a display device 128, a keyboard 130 and a pointing device 132, such as a mouse. The GUI in which the retrieved information can be displayed may be generated on the display device 128. The retrieved portion belongs to a category of the recorded information that is identified based on analyzing previous user inputs, as will now be described.

The system may use a learning function to identify a category of the recorded information that is to be retrieved upon detecting the presence of a pre-identified physical item. For example, the system may monitor, over time, what inputs are made while specific documents are present in the work place 114. Particularly, the system 100 may determine whether there is an association between a certain input field and specific instances of the recorded information 110. This may be done by creating a record 134 in the computer device 126. The record 134 reflects which of the invoices 102 are present in the work place 114 during a period of time, and what entry or entries are made in an input field while particular invoice(s) is/are present. The system 100 can compare the record 134 with the recorded information 110 to determine whether there is an association. For example, the record 134 may comprise the information shown in Table 1:

TABLE 1

| | | Physical Item |
|---|---|---|
| Field # | Entry | Present |
| 1 | 4320892103 | IV11064 |
| | | IV25071 |
| | | IV31002 |
| 1 | 3219839893 | IV11064 |
| | | IV25071 |
| | | IV31002 |
| 1 | 3143244324 | IV11064 |
| | | IV25071 |
| | | IV31002 |
| 2 | May 12, 2004 | IV11064 |
| 2 | Jul. 1, 2004 | IV25071 |
| 3 | SAP AG | IV11064 |

Table 1 associates particular input fields with the data entered therein while specific items are present. It may be understood as follows. Beginning with the first row, input field #1 receives the input 4320892103 while physical items IV11064, IV25071 and IV31002 (for example three invoices) are present in the work place 114. Subsequently, as indicated by the second row of Table 1, the input field #1 receives the input 3219839893 while the same three items are present. The third row of Table 1 indicates that the input field #1 receives the input 3143244324 while those three items are present in the work place. The remaining three rows of Table 1 contain corresponding information for two other input fields #2 and #3.

The recorded information 110, in turn, may comprise the information shown in Table 2:

TABLE 2

| Physical Item | Value 1 | Value 2 | Value 3 |
|---|---|---|---|
| IV11064 | 3143244324 | May 12, 2004 | SAP AG |
| IV25071 | 3219839893 | Jul. 1, 2004 | SAP AG |
| IV31002 | 4320892103 | Jul. 28, 2004 | SAP AG |

Table 2 associates the identifiers 104 (particularly, the information they convey to detector device 120) with values pertaining to each item. In this example, the person performing the recording 108 may have been instructed to record the following data for each item: invoice number, due date and payee. These are in Table 2 referred to as Values 1, 2 and 3, respectively. According to the first row of Table 2, physical item IV11064 has invoice number 3143244324, is payable by May 12, 2004 and the payee's name is SAP AG. The second and third rows may be read similarly.

To determine if there is an association, the system 100 may compare the information in Table 1 with the recorded information 110. The system 100 may use different techniques for this purpose. For example, a data mining technique, a text mining technique, a machine learning technique, a method of statistical analysis or any combinations thereof may be used. As a simple example, the analysis may include the following observations. Beginning with the first row of Table 1, it may be determined, for each physical item that is present, whether the item's row in Table 2 includes the entry received according to Table 1. Here, the entry 4320892103 that was received is not associated with physical items IV11064 or IV25071 according to Table 2. For physical item IV31002, however, the third row of Table 2 indicates that the received entry may be the invoice number.

Based on the identified association, the system 100 may begin associating Value 1 in recorded information 110 with the input field #1. Preferably, however, the system 100 continues this evaluation process for several different items at different times, to make a more reliable determination whether the association exists. This may involve the use of any of the data mining techniques, etc., mentioned above.

The system may seek to identify corresponding associations for input fields #2 and #3 in Table 1. For example, the system may determine that the input field #2 receives entries that match those in the Value 2 column of Table 2. Similarly, the system may determine that the input field #3 receives entries that match those in the Value 3 column of Table 2. Accordingly, the system may determine associations between input field(s) and the recorded information 110. Tables 1 and 2 have been shown with only a few entries for clarity. In other implementations, the recorded information 110, or the record 134, or both, may include many thousands of entries or more, relating to more or fewer input fields than these exemplary ones.

In some embodiments, the learning function is accomplished by the computer device 126 processing information at times when it is idle. That is, in some client-server systems the client computers are personal computers (PCs) that have relatively sophisticated processors. Moreover, these processors may be idle for extended periods of time while no network operations are being performed. This idle time can be used to perform the processing that may be required for the learning function. For example, the computer device 126 continuously updates and stores the record 134 while user inputs are made, and may periodically initiate processing thereof as follows. First, the computer device may determine which items have been registered in record 134. Then, the computer device may obtain from the computer system 106 the part of recorded information 110 that belongs to each of those items. Finally, the computer device can analyze the record 134 and the obtained information to determine whether there are any associations, for example as described with reference to Tables 1 and 2. The executable instructions for these operation may be part of the program 122. Accordingly, some or all of this program may be located on the computer device 126 in some embodiments.

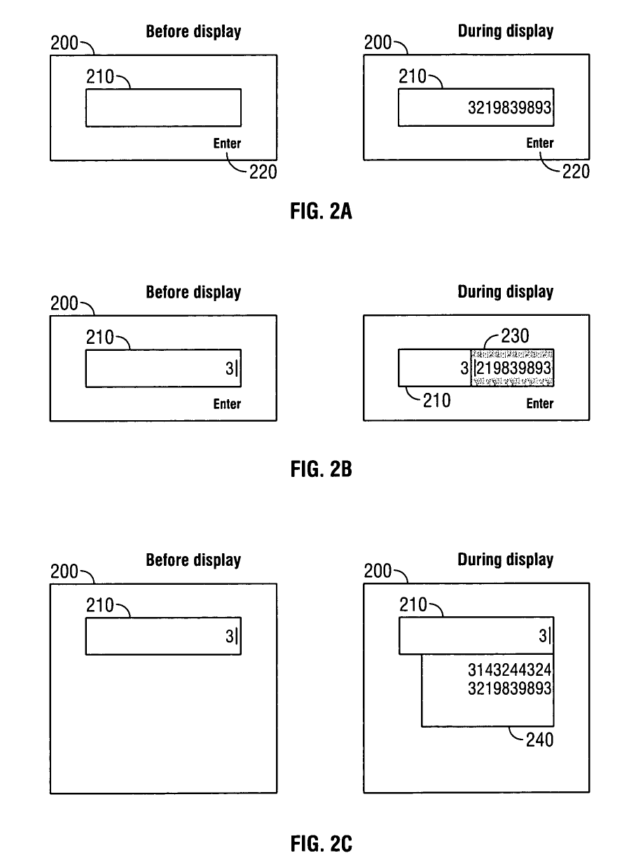

The retrieved portion may subsequently be displayed in a GUI such that it can be used in inputting information into the system 100 that relates to any of the invoices 102A-C. The user may input information into the system using the keyboard and pointing device as will now be described with reference to FIGS. 2A-C.

FIG. 2A is an example of a GUI 200 that can be generated on the display device 128. For example, the user 116 uses the GUI 200 in processing the invoices 102A-C. For clarity, the GUI 200 is shown in a very simple form, comprising a single input field 210 and a user-selectable command. In other implementations, the GUI 200 may include multiple input fields and other features relating to invoice processing.

Assume that the GUI 200 requires the user to enter in input field 210 the invoice number of every invoice present in the area 114 (e.g., on the user's desk) and click on an “Enter” command 220 after each one. For example, the command 220 may cause an electronic version of the invoice to be displayed. Accordingly, the purpose of entering of the invoice number in such implementations may be to access an electronic file in the system 100, such as in the computer system 106. As another example, the command 220 may initiate creation of an electronic document that corresponds to the specific invoice. To perform a similar operation in existing systems, the user may have to place a cursor in input field 210 using the pointing device 132, manually type the invoice number using keyboard 130, and thereafter again use the pointing device 132 to click the command 220.

The system 100, in contrast, may streamline this and other operations. That is, because the input field 210 is dedicated to invoice numbers, the organization may 5 decide that the invoice number should be part of recorded information 110. Upon detecting the invoices 102A-C in work place 114, the relevant invoice number—associated with the one of identifiers 104A-C that belongs to the specific invoice—can be retrieved and displayed in the GUI 200.

The GUI 200 in each of FIGS. 2A-C is first shown “before display” (to the left) and then “during display” (to the right), where “display” refers to the retrieved information being displayed. In the FIG. 2A example, the user need not enter any information in input field 210 before the retrieved information is displayed. After display, then, the retrieved information—invoice number 3219839893—is displayed therein. This exemplary implementation is most useful when only one invoice is present in work place 114 at a time. If the user agrees that this is the invoice number she is currently working on, she can click the command 220 to continue processing that invoice. Alternatively, the user can edit the input field 210 and manually enter another invoice number.

In the FIG. 2B example, the user enters at least one character of an invoice number in the input field 210 before display. During display, the system 100 may then complete the rest of the invoice number with the retrieved portion if there is such a match. For example, a highlighted area 230 contains the remaining characters of an invoice number beginning with “3”. When several invoices are detected in work place 114, the system 100 may await the user's entering at least one character, and thereafter display the retrieved portion in GUI 200. When more than one detected invoice begins with the same number, the system may await several characters until one invoice number can be uniquely identified.

In the FIG. 2C example, the user enters at least one character of the invoice number in the input field 210 before display. During display, the system 100 may display a menu 240 for user selection of an invoice number. For example, the menu 240 may be a drop-down list box. While more than two invoices may currently be present in work place 114, in this example only the two displayed ones—3143244324 and 3219839893—begin with a “3”. Using the pointing device 132 or arrow keys on the keyboard 130, the user may select any of the currently displayed invoice numbers to have it entered in input field 210. In another implementation, the menu 240 may be displayed upon the user placing a cursor in the input field 210 but before the user types anything there.

Accordingly, the GUI 200 may aid the user's input of information into the system 100 by presenting invoice number(s) corresponding to one or more invoices that have been detected in work place 114. The user may also benefit by using the system 100 for lookup purposes, such as to determine what invoices are currently located in work place 114.

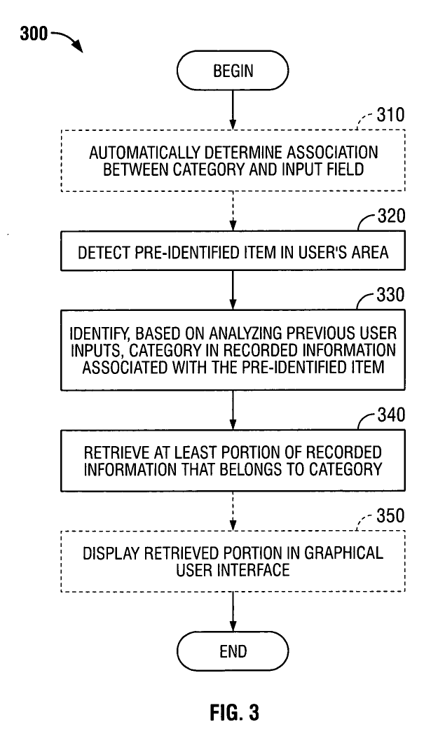

FIG. 3 shows a flow chart of a method 300 according to an embodiment of the invention. Preferably, the method 300 is performed in the system 100. For example, a computer program product can include instructions that cause a processor to perform the steps of the method 300. Method 300 includes the following steps:

Automatically determining, in optional step 310, an association between a category and an input field. For example, the system 100 can monitor user inputs in input field #1 (Table 1) over time to automatically determine an association between it and entries in Table 2 for physical items present in the work place when the inputs are made.

Detecting, in step 320, a pre-identified physical item that is present in a physical area associated with a user. For example, the detector device 120 can detect any or all of the invoices 102A-C that are present in the work place 114 associated with the user 116. Detection may be facilitated by attachments 104A-C on the invoices. The invoices 102A-C may be pre-identified in the recording 108 that stores recorded information 110 in data repository 112.

Identifying, in step 330, in recorded information associated with the pre-identified physical item, a category of the recorded information to be retrieved upon detecting the presence of the pre-identified physical item. The category is identified based on analyzing previous user inputs. For example, the system can analyze entries in records such as Table 1 and Table 2 to identify a category of recorded information to be retrieved, such as the “Value 1” category in Table 2.

Retrieving, in step 340, at least a portion of the recorded information that belongs to the identified category. For example, an invoice number associated with any of the invoices 102A-C may be retrieved from recorded information 110 upon detecting the invoices. Invoice numbers belong to the “Value 1” category in the exemplary Table 2.

Displaying, in optional step 350, the retrieved portion to the user in a GUI. The user can use the displayed retrieved portion in inputting information relating to the pre-identified physical item. For example, the system 100 can display the retrieved invoice number in GUI 200 as follows: 1) automatically in the input field, as shown in the exemplary FIG. 2A; 2) in the input field upon receiving at least one character, as shown in the exemplary FIG. 2B; or 3) in the menu 240 for user selection. User input may optionally be received following the optional display of the retrieved portion.

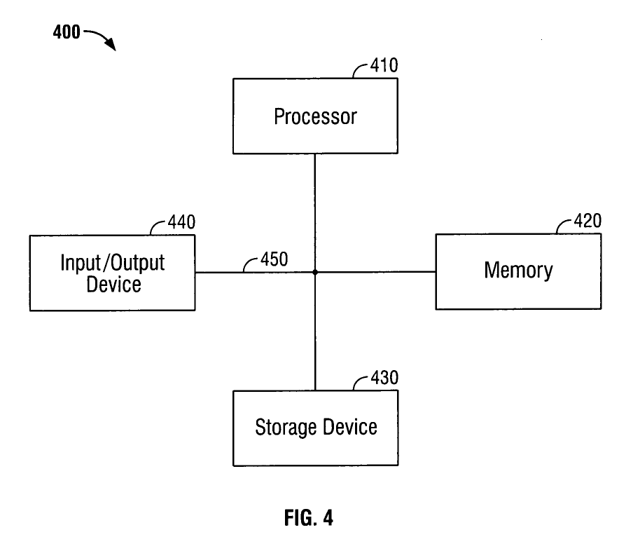

FIG. 4 is a block diagram of a computer system 400 that can be used in the operations described above, according to one embodiment. The system 400 includes a processor 410, a memory 420, a storage device 430 and an input/output device 440. Each of the components 410, 420, 430 and 440 are interconnected using a system bus 450. The processor 410 is capable of processing instructions for execution within the system 400. In one embodiment, the processor 410 is a single-threaded processor. In another embodiment, the processor 410 is a multi-threaded processor. The processor 410 is capable of processing instructions stored in the memory 420 or on the storage device 430 to display graphical information for a user interface on the input/output device 440.

The memory 420 stores information within the system 400. In one embodiment, the memory 420 is a computer-readable medium. In one embodiment, the memory 420 is a volatile memory unit. In another embodiment, the memory 420 is a non-volatile memory unit.

The storage device 430 is capable of providing mass storage for the system 400. In one embodiment, the storage device 430 is a computer-readable medium. In various different embodiments, the storage device 430 may be a floppy disk device, a hard disk device, an optical disk device, or a tape device.

The input/output device 440 provides input/output operations for the system 400. In one embodiment, the input/output device 440 includes a keyboard and/or pointing device. In one embodiment, the input/output device 440 includes a display unit for displaying GUIs as discussed above with reference to FIGS. 2A-C. For example, the device 440 may include the display device 128.

The invention can be implemented in digital electronic circuitry, or in computer hardware, firmware, software, or in combinations of them. Apparatus of the invention can be implemented in a computer program product tangibly embodied in an information carrier, e.g., in a machine-readable storage device or in a propagated signal, for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the invention can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The invention can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

A number of embodiments of the invention have been described. Nevertheless, it will be understood that various modifications may be made without departing from the spirit and scope of the invention. For example, the detector device can be connected to the computer system 106 or to the computer device 126; one or more of the recorded information 110, program 122 and the record 134 may be stored separately, such as on computer device 126. Accordingly, other embodiments are within the scope of the following claims.

1. A method to be performed in a computer system that a person uses in relation with a physical item, the method comprising:
detecting, in a computer system, a pre-identified physical item that is present in a physical area associated with a user;
identifying, in recorded information associated with the pre-identified physical item, a category of the recorded information to be retrieved upon detecting the presence of the pre-identified physical item, the category being identified based on analyzing previous user inputs; and
retrieving at least a portion of the recorded information that belongs to the identified category.

2. The method of claim 1, further comprising displaying the retrieved portion in a graphical user interface, wherein the displayed retrieved portion can be used in inputting information relating to the pre-identified physical item.

3. The method of claim 1, wherein pre-identification of the physical item comprises at least one selected from the group of: manual data entry and automated data entry.

4. The method of claim 1, wherein detecting the pre-identified physical item comprises one selected from the group consisting of: scanning the pre-identified physical item and receiving a communication from the pre-identified physical item.

5. The method of claim 4, wherein scanning the pre-identified physical item comprises reading a bar code located on the pre-identified physical item.

6. The method of claim 4, wherein receiving a communication from the pre-identified physical item comprises receiving a signal from an RFID tag located on the pre-identified physical item.

7. The method of claim 1, wherein the physical area is at least a part of a work place assigned to the user, and wherein the pre-identified physical item is brought into the work place to be available to the user.

8. The method of claim 1, wherein the retrieved portion of the recorded information is displayed in association with an input field on the graphical user interface.

9. The method of claim 8, wherein the retrieved portion is automatically placed in the input field.

10. The method of claim 8, wherein the retrieved portion is displayed upon the user typing at least a character in the input field, if the at least one character is consistent with the retrieved portion.

11. The method of claim 10, wherein the retrieved portion is displayed in a location selected from the group consisting of: the input field and a menu for user selection associated with the input field.

12. The method of claim 1, wherein analyzing the previous user inputs comprises automatically determining an association between the category and an input field of the computer system.

13. The method of claim 12, wherein automatically determining the association comprises monitoring, over a period of time, physical items that are present in the physical area and user inputs made in the input field.

14. The method of claim 13, further comprising creating a record reflecting which of the physical items are present in the physical area when each of the user inputs is made, and comparing the record with pre-recorded information associated with the physical items to identify at least one instance when one of the user inputs made while one of the physical items is present in the physical area matches with at least part of the pre-recorded information associated with the physical items.

15. The method of claim 14, wherein multiple instances including the at least one instance are identified, and wherein the association is determined using at least one of a data mining technique, a text mining technique, a machine learning technique and a method of statistical analysis.

16. A computer program product tangibly embodied in an information carrier, the computer program product including instructions that, when executed, cause a processor to perform operations comprising:
detect, in a computer system, a pre-identified physical item that is present in a physical area associated with a user;
identify, in recorded information associated with the pre-identified physical item, a category of the recorded information to be retrieved upon detecting the presence of the pre-identified physical item, the category being identified based on analyzing previous user inputs; and
retrieve at least a portion of the recorded information that belongs to the identified category.

17. A system for user input of information relating to a physical item, the system comprising:
a computer device with which recorded information that is associated with a pre-identified physical item can be accessed; and
a detector device that detects the pre-identified physical item in a physical area associated with a user, wherein the system retrieves at least a portion of the recorded information upon detecting the pre-identified physical item, the portion belonging to a category of the recorded information that is identified based on analyzing previous user inputs.

18. The system of claim 17, wherein the detector device detects the pre-identified physical item by one selected from the group consisting of: scanning the pre-identified physical item and receiving a communication from the pre-identified physical item.

19. The system of claim 17, wherein the detector device does at least one selected from: reading a bar code located on the pre-identified physical item and receiving a signal from an RFID tag located on the physical item.

20. The system of claim 17, wherein the system monitors, over a period of time, physical items that are present in the physical area and user inputs made in an input field.
